(19) United States
(12) Patent Application Publication
(10) Pub. No.: US 2025/0088547 A1
(43) Pub. Date: Mar. 13, 2025

(54) METHOD FOR ESTABLISHING A COMMUNICATION CONNECTION BETWEEN AT LEAST TWO COMMUNICATION SUBSCRIBERS

(71) Applicant: Heinlein Support GmbH, Berlin (DE)

(72) Inventors: Peer HEINLEIN, Berlin (DE); Dennis KALBHEN, Potsdam (DE); Frederik SCHWAN, Darmstadt (DE)

(73) Assignee: Heinlein Support GmbH, Berlin (DE)

(21) Appl. No.: 18/728,490

(22) PCT Filed: Jan. 12, 2023
(86) PCT No.: PCT/DE2023/200010

§ 371 Date: Jul. 12, 2024

(30) Foreign Application Priority Data
Jan. 14, 2022 (DE) 10 2022 200 415.9

(51) Int. Cl. H04L 65/1069; H04L 9/40

(52) U.S. Cl. CPC H04L 65/1069; H04L 63/04

(57) ABSTRACT

The present invention relates to a method for establishing a communication link (CL) between at least two communication participants (CP), comprising the following steps:
specifying a communication security parameter (CSP) for a security classification of the communication link (CL) to be established,
comparing the specified communication security parameter (CSP) with server security parameters (SSP) of different communications servers (110) in a communications network (100),
selecting a communications server (110) with a server security parameter (SSP) that is better than or equal to the specified communication security parameter (CSP),
establishing the communication link (CL) between the at least two communication participants (CP) via the selected communications server (110).

The present invention relates to a method for establishing a communication link between at least two communication participants, a communications network for the formation of such a communication link and a method for setting up such a communications network.

It is known that communications networks are operated in order to allow communication participants to communicate with each other. For this purpose, communication links between the individual communication participants are necessary. In order to establish these, such communications networks usually have a plurality of communications servers which enable the exchange of data between participant devices of the individual communication participants. In known solutions, this usually involves an automatic assignment of a communications server for a communication link which is to be established. It is also known in principle to impose for example a geographical restriction, for example to specify that a server within Europe, within the United States or within China can be selected for a communication link which is to be established.

A disadvantage of the previous methods is that, although security encryption is possible in principle, i.e. the communication link itself can take different technical security precautions, it is not possible to physically secure the communication link. If, for example, a communication link is to be conducted as a confidential or even a security-classified communication link, this is not possible or only possible to a limited extent with the previous technical solutions. If, for example, a communication link is planned between two employees of a state ministry, a high security classification is often necessary for such an internal communication within the ministry. This can be a ministry security classification, but also an international classification, for example a NATO classification. In order to meet such classifications, in the previous communication links and the previous communications networks, only encryption techniques of different strengths were known for securing the established communication link. However, these technical encryption options can only offer limited security against unwanted interception of such communication links.

It is therefore the object of the present invention to remedy, at least in part, the disadvantages described above. In particular, it is the object of the present invention to be able to assign, in a defined manner, the highest possible degree of security for a communication link to be established, in a cost-effective and simple manner.

The above object is achieved by a method with the features of claim 1, a communications network with the features of claim 12 and a set-up method with the features of claim 13. Further features and details of the invention are disclosed in the dependent claims, the description and the drawings. Naturally, features and details which are explained in connection with the method according to the invention also apply in connection with the communications network according to the invention as well as the set-up method according to the invention and vice versa, so that with regard to disclosure mutual reference is or can always be made to the individual aspects of the invention.

According to the invention, a method is used to establish a communication link between at least two communication participants. For this purpose, the method comprises the following steps:
specifying a communication security parameter for a security classification of the communication link to be established,
comparing the specified communication security parameter with server security parameters of different communications servers in a communications network,
selecting a communications server with a server security parameter that is better than or equal to the specified communication security parameter,
establishing the communication link between the at least two communication participants via the selected communications server.

The core idea of the invention is again based on providing at least two communication participants with a communication possibility by establishing a communication link via a communications server. These can be unidirectional or bidirectional or also multidirectional communication links. Of course, a method according to the invention is not limited to two communication participants, but can in particular also be used for three or very many more communication participants, i.e. for communication conferences. Also, within the meaning of the present invention, a communication link is to be understood as both an audio communication link, a video communication link, but also a mixed communication link for different communication participants.

A method according to the invention is based on the idea that a security classification is already specified before the communication link is established. This is done by specifying a communication security parameter that correlates with this security classification. If, for example, a communication between two communication participants within a ministry is desired, and a topic is to be discussed within this upcoming communication that has a high security category, it is already known before this communication is conducted that a corresponding security classification must be complied with. In order to comply with this security classification, the appropriate communication security parameter can now be specified in association with this security classification. This specification of the communication security parameter can take place in a wide variety of ways. For example, it is conceivable that a communication security parameter is automatically specified, for example through the function or role of the respective communication participant. However, it is also conceivable that such a communication security parameter for the upcoming communication is selected and specified manually by one or more communication participants. A semi-automatic solution, for example by assigning the upcoming communication to a subject area or a sub-area within the working area of one or more communication participants, is also possible in the context of the present invention. Thus, within the framework of the method according to the present invention, the communication security parameter reflects the required security classification for the upcoming communication link.

In order to ensure that the specified security classification in the sense of the specified communication security parameter is also actually adhered to, in the next step of the method according to the invention a comparison of this specified communication security parameter with server security parameters of different communications servers takes place. An active query of one or more, in particular of all communications servers in the communication network can take place. However, it is also possible that within the framework of a method according to the invention a database is specified in which all reachable or available communications servers are stored together with their respective server security parameters.

The server security parameter describes the maximum possible security classification that is possible when communicating via this specific communications server. As will be explained later, different security criteria can be selected in determining the respective server security parameter. In particular, this refers to physical security, i.e. in particular the location of the respective communications server. If, for example, a communications server is located within a ministry, and, for the purpose of a communication link, communication is to take place between two communication participants within the same ministry, preferably within the same building, it may be technically possible to carry out the complete data traffic for this communication link exclusively within this ministry, in particular within the same building. To ensure this, i.e. to physically limit the data traffic to this location, a selection of the communications server within the same building must take place. This is effected through the correlation, according to the invention, between the communication security parameter and the server security parameters.

Based on the above explanation, it is thus now possible, if a minimum standard for security is specified in the form of a communication security parameter, to compare this with a plurality of fundamentally available communications servers and their server security parameters, and then, as a result, to obtain information as to which of the available communications servers would meet the required and specified communication security parameters. It is thereby sufficient if the specified communication security parameter is fulfilled exactly. However, a higher, or, as described in the context of the present invention, better level of security can of course also be guaranteed if, for example, a strengthened level of security is specified in view of different security aspects than is actually required for the upcoming communication link.

As soon as the comparison with the result is completed, at least one, in particular even several possible, and thus selectable, communications servers are available. One of these communications servers that meet the security classification criterion can now be selected and the communication link can then be established via this selected communications server.

The fact that the establishment of the communication link is preceded by a comparison step ensures that the communication link that is subsequently established also complies with the specified security classification in the form of the specified communication security parameter.

Of course, further developments may be provided, so that, for example, the specified communication security parameters, the server security parameters of the selected communications server as well as a comparison or the comparison result of these two security parameters are displayed or otherwise indicated to the respective communication participants. This ensures that the communication link actually complies with the desired and required level of communications security and that this is brought to the attention of the communication participants.

It can be advantageous if, in a method according to the invention, a communication server is selected whose server security parameter is equal to the specified communication security parameter. While in principle it is possible, in order to comply with a given security classification, to select communications servers which provide better security than is actually required, an exact correspondence can ensure that the maximum level of security is reserved for communication links which actually require this. This ensures that only the minimum necessary communication security is always maintained and that correspondingly higher security is left available for other communication links which actually require this higher security.

It can also be advantageous if, in a method according to the invention, the communication security parameter and the server security parameter have an identical or essentially identical form, in particular selected from at least one of the following:
physical security
local security
technical security.

As already explained, in addition to an already known security achieved through encryption technologies of an established communication link, one or more further security aspects can be actively taken into account in the context of the present invention. For example, physical security can represent the actual location and positioning of a communications server within a building and the corresponding physical network cabling. Local security can for example relate to the correlation of the location of a communications server with the location of communication participants, for example in the same ministry and/or even in the same building. This local security must be distinguished in particular from geographical information, such as that which can be used in the selection of communications servers for individual countries. Last but not least, it is also possible for technical security to be used as a security parameter. This can for example relate to the accessibility of communications servers or corresponding connection points. The shielding or the exclusivity of the communication lines used can also be described as technical security. It should be noted that the above list is a non-exhaustive list. In particular, it is also possible that a security parameter combines two or more different forms of security, or that different forms of security are contained within a security parameter as partial security parameters. It should also be noted that the security parameters can, in addition or alternatively, take into account different types of links. For example, a dial-up option under the so-called VPN protocol can also be used as a “virtual private network” with a method according to the invention, and can be taken into account by this method.

It can have further advantages if, in a method according to the invention, the specification of the communication security parameter is carried out by at least one communication participant. As already explained, it is possible to specify the communication security parameter automatically, semi-automatically or manually. Actively and deliberately specifying a communication participant means that the latter can influence the security standard of the upcoming communication which they want or even need. The specification of the communication security parameter thus becomes part of the establishment protocol for the communication link and, in particular, is already included when an invitation for the communication link is sent to all other communication participants. As an alternative to specification by a communication participant, an administrator or a communications manager of the upcoming communication link can also specify the communication security parameter.

In addition, it has advantages if, in a method according to the invention, participant security parameters of the communication participants are recorded, which are compared in particular with the specified communication security parameter and/or with the server security parameter of the selected communications server. This introduces an additional form of a security parameter which is in particular identical to the form of the server security parameter and/or to the form of the communication security parameter. The participant security parameter thereby provides information as to which maximum security classification is in fact possible for this participant. For example if, for a particular security classification, a communication link is only possible within a ministry building, but a communication participant is located outside of this building, this may make it impossible to comply with the required security classification. In order to know this before establishing the communication link, and to inform the individual communication participants about the impossibility of the communication link under the given security classification, this comparison is already carried out in advance. The participant security parameters make it possible to indicate a conflict between the specified security requirement and the desired communication. In this way, it can also be ensured that, in the example mentioned, the communication participant outside of the ministry is informed that they need to log in to the ministry, for example via a VPN access, because otherwise they would not fulfil the required participant security parameter which is necessary in order to comply with the communication security parameters for this communication link.

It can also be advantageous if, in a method according to the invention, a communications server with the best available and/or usable server security parameter is always selected. This ensures that a stronger security level can be guaranteed than the required minimum security level for the respective communication link. This also makes it possible to always choose the most secure communications servers, in particular with a higher security level than actually requested for the respective communication link. The security aspect in the performance of a method according to the invention can be maximised with this embodiment. In addition to the maximum available security, depending on the communication participants the maximum usable security can also be used for the selection of the corresponding communications server. In particular, this applies if the communications server with maximum security cannot be used because a communication participant does not have access to this communications server.

It brings further advantages if, in a method according to the invention, the specification of the communication security parameter is based on a participant security parameter stored for at least one communication participant. As already explained, this participant security parameter can be set manually by the respective communication participant. An automatic assignment, for example through the connection point used or other location information relating to the communication participant, is also possible here in principle. The participant security parameters can be selected or specified differently for each communication link. The specification makes it possible then to check this participant security parameter and in particular to check whether the desired communication link is possible at all with the given participant security parameter while complying with the specified communication security parameters.

It is also advantageous if, in a method according to the invention, a check on the load on the communications server is carried out, in particular only the communications server with a server security parameter which is better than or equal to the specified communication security parameter. This makes it possible to also take into account a load situation, in addition to the security classification, when selecting the communications server. This load check is preferably limited to the communications servers that are possible at all for the requested communication link. Communications servers which, due to the previous comparison, are associated with an excessively low security classification in the form of the server security parameter are therefore, in particular, not queried regarding their load situation in this embodiment. This ensures that not only the maximised security is maintained, but in addition an improved load distribution can be achieved across all possible communications servers of the desired security classification.

It can be advantageous if, in a method according to the invention, a link is established between at least three communication participants. While in principle even unidirectional or bidirectional communication links between exactly two communication participants already bring the advantages according to the invention to effect, the application of the method to three or more communication participants brings significantly further-enhanced advantages. In particular, because the method can now comply with the desired security classification automatically or at least partially automatically, it can be ensured very easily, and above all with a high level of security, even in the case of a high number of communication participants, i.e. in particular in a conference situation involving a plurality of communication participants, that the desired security classification can also actually be complied with through the corresponding establishment of the communication link.

It can be advantageous if, in a method according to the invention, the communication link is established as a text link, as an audio link and/or as a video link. Combined text/audio/video links are also possible in principle. Nor is the method limited to establishing the same form of communication link for all communication participants. For example, it is possible that part of the communication links to some communication participants are provided purely via audio and/or text, to others in combination with video. It is also possible in principle for the individual communication participants to switch between text, video and audio connections during the ongoing communication link. However, it is crucial that it is ensured that the required security classification is always adhered to for the ongoing communication link. Even if a change of a communications server should be necessary during an ongoing communication link, the method according to the invention will ensure that, when selecting the new communications server, the security level specified by the comparison explained above is still complied with by the specified communication security parameters. A text connection can for example be understood to be a chat link. Signalling information, for example regarding the availability of individual communication participants, is also in principle conceivable as a form for the communication link.

It brings further advantages if, in a method according to the invention, after the communication link has been established, a change of the communications server occurs, in particular depending on a change in the communication participants. Thus, it is possible in principle for the communication participants to join or withdraw from an ongoing communication link. As has already been explained, participant security parameters can in principle be taken into account and thus make possible or impossible different security classifications for the communication link. If, for example, a communication link with the highest security classification is in progress and a new communication participant now joins this communication link whose geographical circumstances do not allow the maximum security level, this would lead to the impossibility of this communication link via the currently used communications server. This can lead to two consequences. On the one hand, it can be displayed to the new communication participant that it is not possible for them to join the ongoing communication link due to their current participant security parameter. On the other hand, the wish of the new communication participant could be displayed to the communication participants already present in the communication link, with the information that admitting the new communication participant would result in a deterioration of the security situation. If this is allowed, or if the communication participants allow this, it is possible to switch to a communications server which, in technical terms and from a security point of view, allows the new communication participant to be connected. However, this change preferably involves an interruption, so that the communication participants are given a clear visual or auditory indication that a change in the communications server and thus a change in the security classification has taken place. Of course, this can also be done in the opposite direction, for example if the departure of a communication participant from the communication link means that increased security is now possible again, since the remaining communication participants are now within range of a communications server with an improved server security parameter. Here, too, the described change can be carried out either manually by selecting the communication participants or even automatically.

The subject matter of the present invention also includes a communications network comprising a plurality of communications servers for establishing a communication link between participant devices of at least two communication participants by means of a method according to the invention. Each communications server is assigned a server security parameter depending on a security classification. Furthermore, this communications network has a plurality of connection points for connecting participant devices of communication participants to at least one of the communications servers. A communications network according to the invention thus brings with it the same advantages as have been explained in detail with reference to a method according to the invention. The connection points can be real connection points, for example in the form of network sockets within a communications network, within a building or a ministry. Virtual connection points, for example connection points via VPN, are also conceivable in principle in the context of the present connection. Connection points can also be wired as well as wireless, for example formed by WiFi access points. The method according to the invention preferably runs on the communications server, on one or more of the communication participants in the form of the participant devices, and/or on a network controller for the communications network. A combined execution at different locations in the communications network is also possible in principle.

A further subject matter of the present invention is a set-up method for setting up a communications network according to the present invention, comprising the following steps:
determining a security classification of all communications servers of the communications network,
assigning server security parameters and the communications servers based on the determined security classifications.

A set-up method according to the invention thus brings the same advantages as have been explained in detail with reference to a communications network according to the invention and with reference to a method according to the invention. If a communications network is set up, when setting up the communications network the administrator can now also assign a security classification to the individual communications servers based on the current security situation and the location and design of the individual communications servers. For example, all communications servers within a ministry building receive a first security parameter. If communications servers are located within another building, but assigned to the same communications network of the ministry, then these receive a different server security parameter which is worse compared with the first group of communications servers. If communications servers outside the ministry are proposed, within the framework of the set-up method these can be assigned an even lower level as a security classification and thus also a further downgraded security parameter. In other words, the communications network is classified through the set-up method, and all communications servers that are available in principle are assigned exactly one server security parameter specific to this communications server. If a communication link is to be established, the comparison already explained several times can be carried out. It should also be noted that the server security parameters can in principle take the form of absolute server security parameters, but also relative server security parameters. An absolute server security parameter is one that always has the same value regardless of the relation to the communication participants. A relative server security parameter can for example include the reference to a building for the location of this exact communications server. If the communication participants for a communication link are in the same building as the communications server, then based on this relative relationship to the communication participants, a different absolute value can be selected for the relatively specified server security parameter than would be the case if one or more of the communication participants were located in a different building relative to the communications server. A combination of relative and absolute server security parameters is also possible in principle.

It can be advantageous if, in such a set-up method, when a new communications server is added to the communications network, the steps of determining and assigning are carried out for this new communications server. In addition or alternatively, it is of course also possible to remove communications servers, in which case these are then completely unavailable for a method according to the invention.

Further advantages, features and details of the invention are explained in the following description, in which exemplary embodiments of the invention are described in detail with reference to the drawings. The features mentioned in the claims and in the description may in each case be essential to the invention individually or in any combination. In each case schematically:

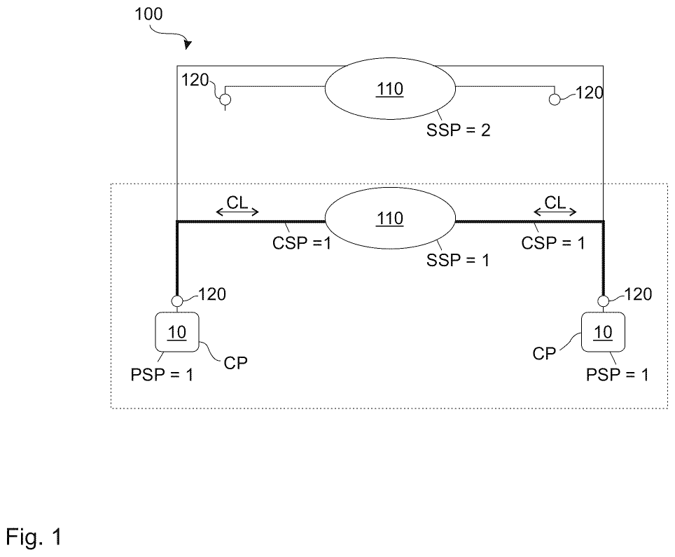

FIG. 1 shows an embodiment of a communications network with an established communication link,

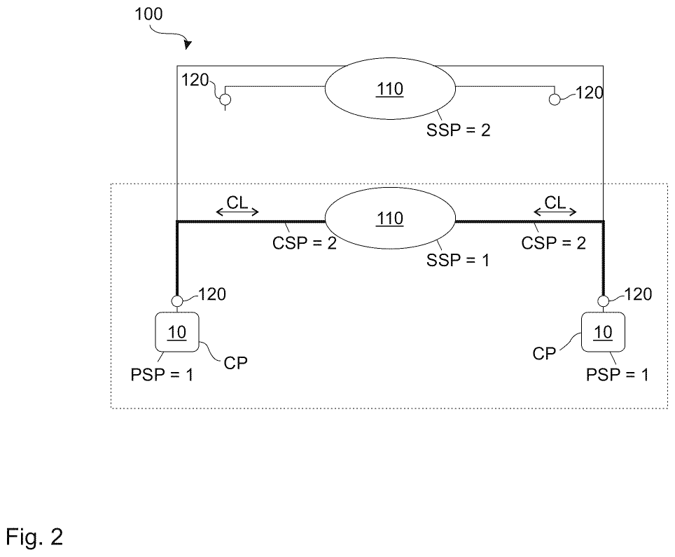

FIG. 2 shows the embodiment of FIG. 1 with a different communication link,

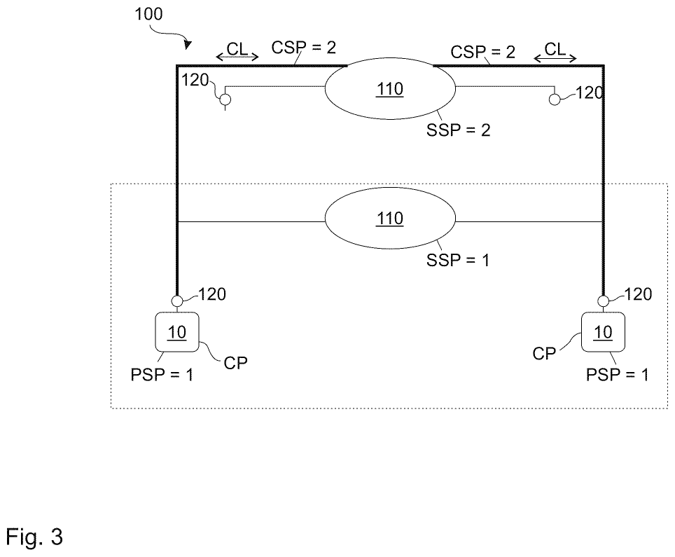

FIG. 3 shows the embodiment of FIGS. 1 and 2 with a different communication link,

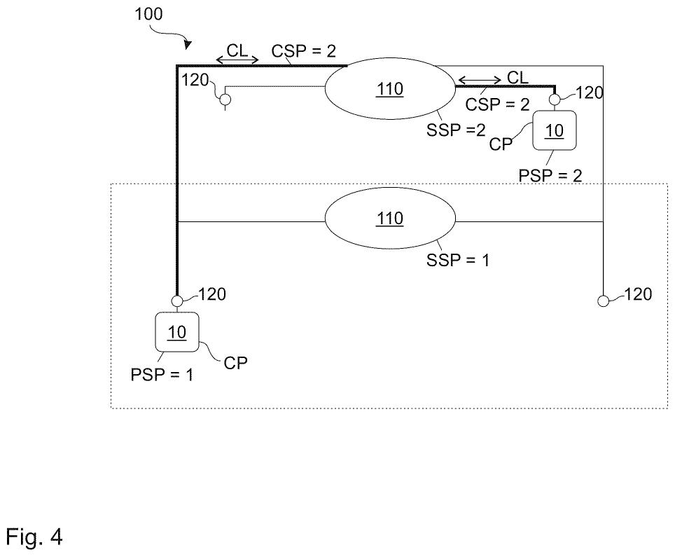

FIG. 4 shows the embodiment of FIGS. 1 to 3 with a different communication link,

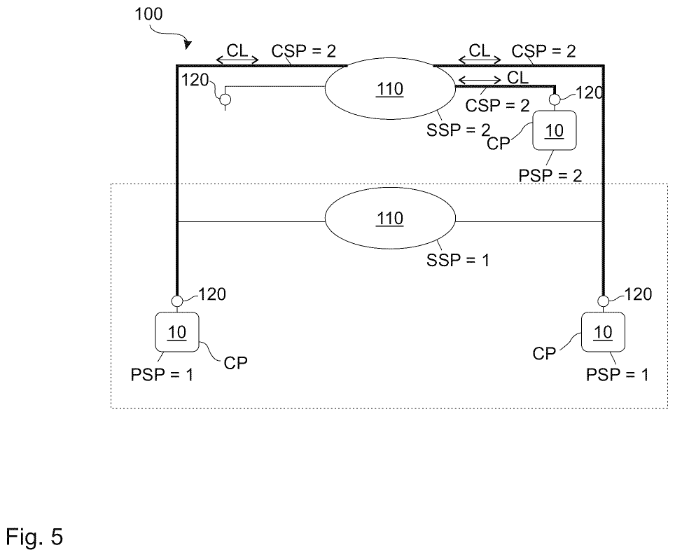

FIG. 5 shows the embodiment of FIGS. 1 to 4 with a different communication link,

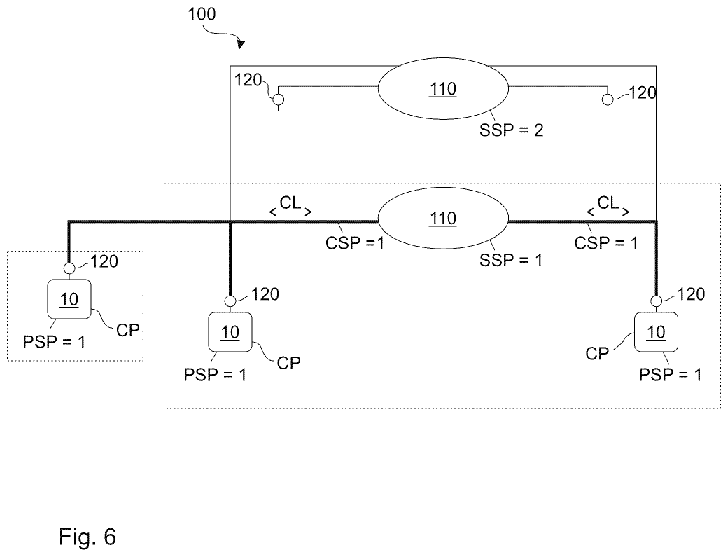

FIG. 6 shows the embodiment of FIGS. 1 to 5 with a different communication link,

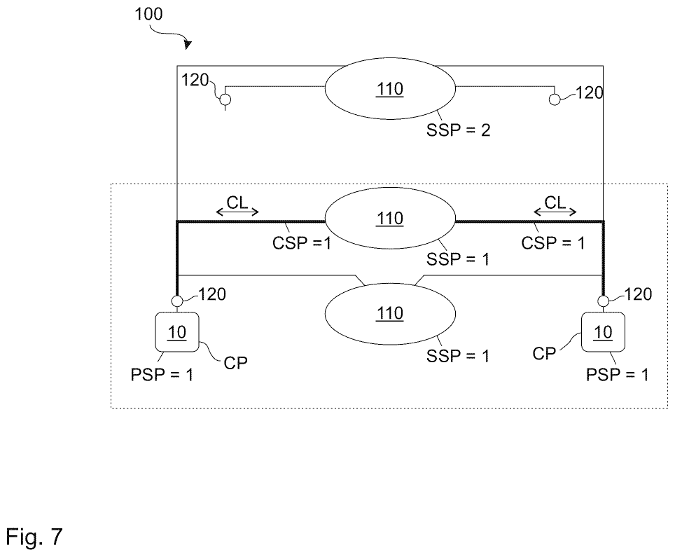

FIG. 7 shows another embodiment of a communications network with a communication link.

FIG. 1 shows schematically a very simple and exemplary structure of a communications network 100. Two communications servers 110 are shown here, in a highly simplified form. A box marked by a dotted line is used to represent a building, for example of a ministry, within which the lower communications server 110 is located. The other communications server 110, shown above in FIG. 1, is located outside of this building, but still within range of this ministry. Due to the fact that different security levels exist when setting up this communications network 100 due to the physical location of the two communications servers 110, these can fulfil different security classifications. For communication within a building, a higher and better security classification can be assumed than if the communication leaves the building (the dotted line in FIG. 1). Therefore, during setup, the communications server 110 within the dashed line for the building was assigned a better server security parameter SSP in the form of a value of 1, while the communications server 110 outside the building has been assigned a worse server security parameter SSP with a value of 2.

If a communication link CL between two communication participants CP is desired—in the example of FIG. 1 these are located within the building—they can specify a communication security parameter CSP, manually, or automatically through the location within the building. This is again specified here with the highest security classification, with an absolute value of 1. This means that in order to establish the communication link CL, in a first step it is compared which of the available communications servers 110 meet the specified communication security parameter CSP with their respective specific server security parameter SSP. In the present case, this is only the case for the lower communications server 110, so that due to the communication security parameter CSP with the value of 1 being consistent with the server security parameter SSP with the value of 1, this communications server 110 is now selected and the communication link CL is established in the manner shown in FIG. 1. In other words, as a result a communication link CL between the two participant devices 10 within the building has been established via the individual connection points 120.

It can also be seen from FIG. 1 that in this case each of the individual communication participants CP has a participant security parameter PSP which also has a value of 1 due to the location within the same building. This can be taken into account in particular when specifying the communication security parameter CSP. FIG. 2 shows a very similar situation to FIG. 1. However, in this case a reduced security classification was specified. For example, one of the communication participants CP could manually decide that the topic to be discussed has a lower security relevance, and thus a lower security classification is necessary. Therefore, the value 2 was specified manually as the communication security parameter. Due to the fact that the lower communications server 110 now actually has a better server security parameter SSP with the value 1 compared to the existing server security parameters SSP, the communication link CL could be set up in an identical way to FIG. 1. Alternatively, however, it would also have been possible, as FIG. 3 shows, that the upper communications server 110 would have been selected for this communication link CL due to the reduced security requirement. This is shown in FIG. 3, so that the communications server 110 outside of the building has now been selected as the communications server between the identical communication participants CP with the two participant security parameters PSP equal to 1, inside the building. Different priorities can thereby be set. For example, it is conceivable that a set-up according to FIG. 3 will automatically follow in that only the required security level is selected. It is also possible that the best possible security level is always selected as shown in FIG. 2, i.e. even if the security classification would allow another communications server 110, the best, and thus most secure, available communication link CL is established.

FIG. 4 shows a different situation in this exemplary communications network 110. The other communication participant CP is now located outside of the building shown (dotted line in FIG. 4). This means that this communication participant CP has a participant security parameter PSP of 2. If the first communication participant CP inside the building with the participant security parameter of 1 were to desire a communication link with the communication security parameter CSP of 1, this would not be possible on the basis of comparing the participant security parameter PSP with the communication participant CP located outside of the building. However, since only a communication security level with a communication security parameter CSP of 2 is required here, this communication is possible in principle and proceeds in the same way through comparison and selection with the server security parameter SSP via the communications server 110 located outside.

FIG. 5 shows a combination of the situation shown in FIGS. 1 to 4, in this case with three communication participants CP. Here too, a desired comparison was carried out for the participant security parameter PSP, the communication security parameter CSP and the server security parameter SSP. To ensure that everyone can communicate with each other, the communication security parameter CSP equal to 2 was selected here in order to establish the communication link CL accordingly via the external communications server 110 with the server security parameter SSP equal to 2.

FIG. 6 shows another variant of how a virtual integration of communication participants CP can take place. Here, the third communication participant CP is so to speak virtually integrated into the building's network via a VPN access point outside of the building. This also makes it possible to establish a highly secure communication link CL with a communication security parameter CSP of 1, despite the fundamentally external arrangement of this third communication participant CP on the left hand side.

FIG. 7 shows schematically that significantly more complex communications networks 100 are of course possible. In particular, it is also possible that, not only a single communications server 110, but, as shown here again by way of example, two or more communications servers 110 can be arranged within a security level, in this case within the building. Thus, if two or more communications servers 110 with the same server security parameter SSP can be selected, the load, i.e. the traffic, via the respective communications server 110 can also be taken into account for the establishment of the communication link CL, and as uniform as possible a distribution and utilisation of all possible and selectable communications servers 110 can be achieved.

The above explanation of the embodiments describes the present invention exclusively in the context of examples. Of course, individual features of the embodiments can be combined with each other freely, where technically expedient, without departing from the scope of the present invention.

### LIST OF REFERENCE SIGNS

10 participant device
100 communications network
110 communications server
120 connection point
CL communication link
CP communication participant
CSP communication security parameter
SSP server security parameter
PSP participant security parameter

1. Method for establishing a communication link (CL) between at least two communication participants (CP), comprising the following steps:
specifying a communication security parameter (CSP) for a security classification of the communication link (CL) to be established,
comparing the specified communication security parameter (CSP) with server security parameters (SSP) of different communications servers in a communications network,
selecting a communications server with a server security parameter (SSP) that is better than or equal to the specified communication security parameter (CSP),
establishing the communication link (CL) between the at least two communication participants (CP) via the selected communications server.

2. Method according to claim 1, wherein a communications server is selected whose server security parameter (SSP) is equal to the specified communication security parameter (CSP).

3. Method according to claim 1, wherein the communication security parameter (CSP) and the server security parameter (SSP) have an identical or substantially identical form, in particular selected from at least one of the following:
physical security
local security
technical safety

4. Method according to claim 1, wherein the specification of the communication security parameter (CSP) is made by at least one communication participant (CP).

5. Method according to claim 1, wherein participant security parameters (PSP) of the communication participant (CP) are recorded which are, in particular, compared with the specified communication security parameter (CSP) and/or with the server security parameter (SSP) of the selected communications server.

6. Method according to claim 1, wherein a communications server with the best available and/or usable server security parameter (SSP) is always selected.

7. Method according to claim 1, wherein the specification of the communication security parameter (CSP) is based on a participant security parameter (PSP) stored for at least one communication participant (CP).

8. Method according to claim 1, wherein a check of the load on the communications server is carried out, in particular only the communications server with a server security parameter (SSP) which is better than or equal to the specified communication security parameter (CSP).

9. Method according to claim 1, wherein a link is established between at least three communication participants (CP).

10. Method according to claim 1, wherein the communication link (CL) is established as a text link, as an audio link and/or as a video link.

11. Method according to claim 1, wherein after the communication link (CL) has been established, a change of the communications server occurs, in particular depending on a change in the communication participants (CP).

12. Communications network comprising a plurality of communications servers for establishing a communication link (CL) between participant devices of at least two communication participants (CP) by means of a method having the features of claim 1, wherein a server security parameter (SSP) is assigned to each communications server depending on a security classification, further having a plurality of connection points for connecting participant devices of communication participants (CP) to at least one of the communications servers.

13. Set-up method for setting up a communications network with the features of claim 12, comprising the following steps:
determining a security classification of all communications servers of the communications network,
assigning server security parameters (SSP) to the communications servers based on the determined security classifications.

14. Set-up method according to claim 13, wherein when a new communications server is added to the communications network, the steps of determining and assigning are carried out for this new communications server.
